(19) United States
(12) Patent Application Publication
(10) Pub. No.: US 2007/0226745 A1
(43) Pub. Date: Sep. 27, 2007

(54) Method and system for processing a service request

(75) Inventors: Robert Haas, Adliswil (CH); Roman A. Pletka, Horgen (CH)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/712,155

(22) Filed: Feb. 28, 2007

(30) Foreign Application Priority Data
Feb. 28, 2006 (EP) 06110509.4

(51) Int. Cl. G06F 9/46

(52) U.S. Cl. 718/105

(57) ABSTRACT

A method and system for performing tasks when processing a client service request. The service request is processed by a group of processing elements including a main processing element and at least one offloading processing element. A subset of tasks is assigned to at least one of the offloading processing elements. When a service request is received from the client at the group of processing elements, each offloading processing element determines whether processing of the service request requires performing a task contained in the subset of tasks assigned to the respective offloading processing element. If processing of the service request requires performing tasks comprised in the subset of tasks assigned to the respective offloading processing element, those tasks are performed and outputs of the tasks are transmitted back directly from the offloading processing element to the client.

### TECHNICAL FIELD

The present invention relates to a method, a computer program product and a system for performing tasks when processing a service request, in particular a service request of a client, by a group of processing elements. The group of processing elements comprises a main processing element and at least one offloading processing element.

### BACKGROUND OF THE INVENTION

Processing elements are computing elements dedicated to offer specific services within a computational environment. In computer networks for example, processing elements, usually called servers in this context, offer certain services, like web-, file- or database-services. Other entities, the clients, can request these services via the network. Another example is the use of modules as processing elements, which can be hard- or software implemented, within a single computer. They offer specific services, for example data processing like encryption or decryption, to clients via internal interfaces, e.g. application programming interfaces (API). The requesting entities (clients) are for example the operating system or applications executed on the computer.

The concept is advantageous since the functions provided by a processing element only have to be implemented once, whilst being available to a plurality of clients. Another advantage is, that the processing element can be specifically designed to perform better on the service it provides, e.g. by using application specific integrated circuits (ASICs).

Problems can arise, if the processing element is overloaded and does not have enough computing resources to process all incoming requests appropriately. A solution to this problem is to provide in addition to a main processing element, to which the request is transmitted, one or more further processing elements, called offloading process elements, to which a part of the duty is outsourced. This approach is usually referred to as proxy processing. In network environments, the respective main processing element is called a proxy server. Usually, offloading is done in a transparent fashion, meaning that the requesting client does not notice that tasks related to the service are not performed by the main processing element itself. The client solely interacts with the main processing element. No direct communication is carried out between client and the offloading processing element. An advantage of the proxy-concept is that the system performance can be scaled easily without the need to introduce any changes in the interaction between client and main processing element, for example concerning the protocol used. A disadvantage is that the whole service breaks down if the main processing element fails, even if the offloading elements still function. Also data effectively transferred from an offloading processing element to the client is routed via the main processing element, therefore increasing the load on the element.

It is a challenge to provide a more reliable and more effective method, system and a computer program product for performing tasks when processing a service request.

### SUMMARY OF THE INVENTION

According to one aspect of the invention, a method for performing tasks when processing a service request by a group of processing elements is provided, where the group of processing elements comprises a main processing element and at least one offloading processing element. Each offloading processing element is adapted to communicate with the main processing element. The method comprises a step of first assigning, for at least one of the offloading processing elements, a subset of tasks to be performed by the respective offloading processing element. In a second step a service request is received and subsequently it is determined, by each offloading processing element, whether processing of the service request requires performing a task contained in the subset of tasks assigned to the respective offloading processing element. Then, in a further step, one or more tasks are performed by the respective offloading processing element, if processing of the service request requires performing tasks comprised in the subset of tasks assigned to the respective offloading processing element.

Since the offloading processing elements determine individually whether processing of the requested service requires performing an offloaded task, they can perform the task and assist in providing the service without any involvement of the main processing element. The method is more reliable since a failure of the main processing element does not preclude the offloading processing elements from operating.

According to a second aspect of the invention, a method for performing tasks when processing a service request of a client by a group of processing elements is provided. Again, the group of processing elements comprises a main processing element and at least one offloading processing element and each offloading processing element is adapted to communicate with the main processing element. In addition to the method according to the first aspect of the invention, the client is adapted to communicate with the main processing element and with each of the offloading processing elements. The method comprises the steps of the method according to the first aspect of the invention, with the additional step of multicasting the service request from the client to the group of processing elements, before the request is received. The advantages of the second aspect of the invention correspond to the advantages of the first aspect of the invention.

In a preferred embodiment of the second aspect of the method, it comprises the additional step of sending outputs of the one or more tasks performed by one of the offloading processing elements from the respective offloading processing element to the client. In this way, data is not relayed via the main processing element thereby decreasing the load on the main processing element.

In a preferred embodiment of the first and the second aspect of the method, it comprises the additional step that, if further tasks than the tasks performed by the offloading processing element are required to complete processing of the service request, performing the further tasks by the main processing element. In this way, offloading elements can contribute to the handling of requests that can not be completely offloaded.

In a further preferred embodiment of the first and the second aspect of the method, the first step of assigning the subset of tasks is performed once and the further steps are performed for a plurality of service requests. The first step of assigning the subset of tasks to the offloading processing elements, i.e. the initializing step in which an offloading processing relationship is established, can eventually comprise a data volume to be exchanged between main processing element and the offloading processing element. This way, exchange of data to establish the offloading relationship is only performed once for a plurality of service requests.

In a further preferred embodiment of the first and the second aspect of the method, the first step of assigning the group of tasks comprises transmitting an initialization request from the main processing element to the offloading processing element, the initialization request comprising a task descriptor. Using a task descriptor allows to define the tasks to be offloaded in a more compact and more efficient manner.

In yet a further preferred embodiment of the first and the second aspect of the method, the task descriptor comprises a task identifier referring to a predefined table of tasks and at least one message classifier assigned to the task identifier. The step of determining, by each offloading processing element, whether processing of the service request requires performing a task contained in the subset of tasks assigned to the respective offloading processing element comprises analyzing the service request using the at least one message classifier. The task performed by the respective offloading processing element depends on the task identifier assigned to the at least one message classifier. This way, a correlation between requests and tasks to be performed is expressed via the classifier-task identifier pair. Even tasks that are not explicitly named in a service request, but are implicitly contained in the request and have to be performed in order to respond to the request, can be determined by the offloading processing element due to the correlation expressed by the classifier-task identifier pair. Offloading processing elements are not directly referred to by the requesting client and yet react on the request. The method is therefore transparent to the client.

In a further preferred embodiment of the first and the second aspect of the method, the method comprises the additional step of sending a notification message from one of the offloading processing elements to the main processing element after the respective offloading processing element has performed the one or more tasks required to process the service request. This way, the main processing element can monitor, if handling of the service request is completed even if it is not involved directly.

In a further preferred embodiment of the first and the second aspect of the method, the method comprises the additional step of transmitting data required to perform the one or more tasks by one of the offloading processing elements from the main processing element to the respective offloading processing element. This way, an offloading processing element can perform a task, even if it does not have all information required to perform the task available all the time.

In a further preferred embodiment of the first and the second aspect of the method, the method comprises the additional step of repeatedly transmitting alive messages from each offloading processing element to the main processing element. An alive message is a message by the sender that confirms that the sender is still functioning. In yet a further embodiment, the method comprises the additional step of reassigning or removing, for one of the offloading processing elements, the subset of tasks to be performed by the respective offloading processing element if no alive message of one of the other offloading processing element is received for a predetermined time interval. Repeatedly transmitting alive messages allows for a check, whether the offloading processing elements are still up and functioning. If not, the corrupt offloading relationship can be re-established with another offloading processing element.

According to a third aspect of the invention, a computer program product is provided. The computer program product comprises a computer-readable medium embodying program instructions executable by at least one processor to perform a method as described above.

According to a fourth aspect of the invention, a system for performing tasks when processing a service request comprising a group of processing elements is provided, with the group of processing elements comprising a main processing element and at least one offloading processing element. Each offloading processing element is adapted to communicate with the main processing element. The system is characterized in that it is operable to perform a method as described above.

The advantages of the third and fourth aspect of the invention correspond to the advantages of the first aspect of the invention.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1, a first embodiment of a system comprising offloading processing elements,

FIG. 2, a second embodiment of a system comprising offloading processing elements,

FIG. 3, a flow chart for initializing an offloading processing element, and

FIG. 4, a flow chart for performing tasks by an offloading processing element upon receipt of a request.

### DETAILED DESCRIPTION OF THE INVENTION

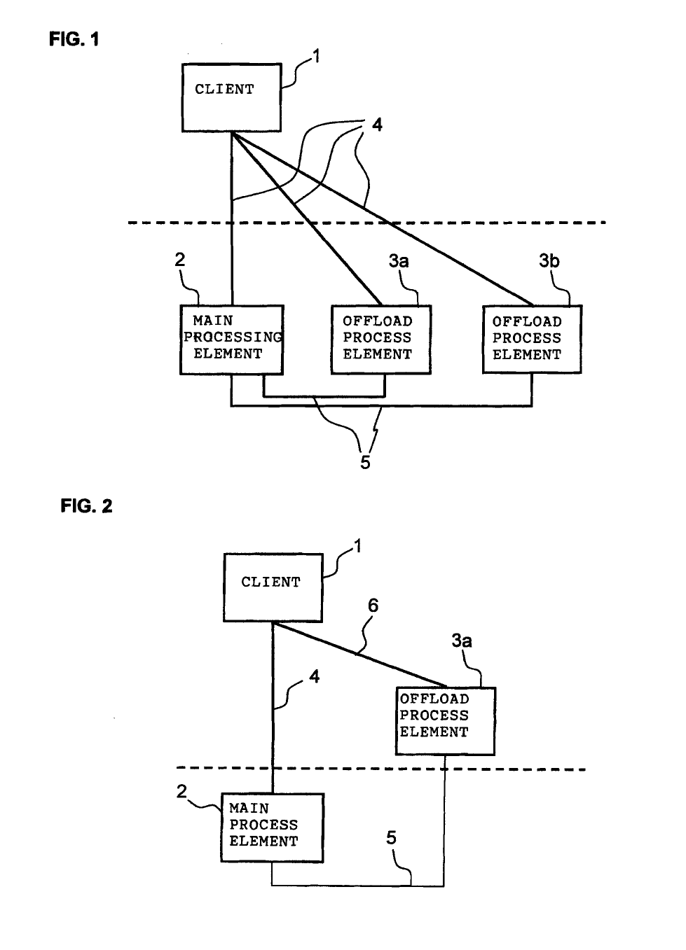

The system shown in FIG. 1 comprises a client 1 connected to a main processing element 2 and to offloading processing elements 3 by means of a network connection 4. By way of example, two offloading processing elements 3a and 3b are shown here. Their number is, however, not limited in any way. If, in the following, a reference sign comprises a letter (a, b) the reference sign refers to the individual element. If no letter is used, any of the individual elements are referred to, for example offloading processing element 3 refers to offloading processing element 3a or offloading processing element 3b or both of them.

The system of FIG. 1 could represent a client server configuration, in which the client 1 requests a service from a server, the server consisting in this case of the main processing element 2 and the offloading processing elements 3.

In such a configuration client 1 is usually spatially separated from the server, here the main processing element 2 and the offloading processing elements 3. In the figure, the separation is indicated by the dashed line. All known types of network connections could be used as network connection 4 and further network connection 5, for example Ethernet or Fiber Channel. Even if depicted separately in FIG. 1, network connection 4 and further network connection 5 could belong to the same network. Also, network connection 4 and further network connection 5 do not necessarily have to be physical point-to-point connections as depicted.

The system is particularly well-suited, but not limited, for cases in which the requested service might comprise tasks which can be handled independently from other tasks to execute the service. By way of example, the embodiment of FIG. 1 represents parts of a storage area network file system. Within the storage area network file system the client 1 accesses the metadata of files from the main processing element 2 for files stored on a storage device, which, for simplicity, is not shown in FIG. 1.

One task within a storage area network file system is key management, for example to provide the client 1 with appropriate keys to decrypt encrypted files received from the file server. The key management is part of a metadata service, performed by a metadata server represented by the main processing element 2 of FIG. 1. In order to take some load off the main processing element 2, the key management is offloaded to the offloading processing element 3a.

In order to offload tasks an offloading relationship is established between the main processing element 2 and the offloading processing element 3a. This is achieved by an initialization step in which the main processing element 2 provides the respective offloading processing element 3a with one or more task descriptors. Therefore, the main processing element 2 transmits an initialization request to the offloading processing element 3, the initialization request comprising the task descriptor. A task descriptor comprises at least one task identifier (id) and at least one message classifier, which is used to identify requests that require performing the respective task described by the task id. The task identifier refers to a predefined table of tasks. The message classifier is assigned to the task identifier.

If a key is requested by the client 1, the request is multicast to the group of processing elements responsible for key management, here the main processing element 2 and the offloading processing elements 3. Multicasting requests are, for example, supported by UDP (User Datagram Protocol).

Assuming that offloading processing element 3a was initialized to perform the key management, it will now determine that performing tasks as described by the task ids contained in the task descriptor is required. Determination is based on using the message classifiers also associated to the task descriptor. Having performed the task, the output of the task, here the appropriate key to decrypt the file, is sent back to the client 1.

In summary, after the offloading relationship has once been established in the initialization step, the key request is handled by the offloading processing element 3a interacting with the client 1 without any assistance from the main processing element 2. Key requests are even responded to, if the main processing element 2 does not work properly at the time of the request. In the system shown in FIG. 1, other tasks connected to key management might be offloaded from the main processing element 2 to the offloading processing element 3b. The offloading processing element 3b might also be reserved to replace offloading processing element 3a in case it breaks down. It might also be possible to offload the key management to both offload processing elements 3a and 3b. In the latter case additional negotiation between the two offloading processing element 3a and 3b will be carried out in order to share out the tasks between the two of them.

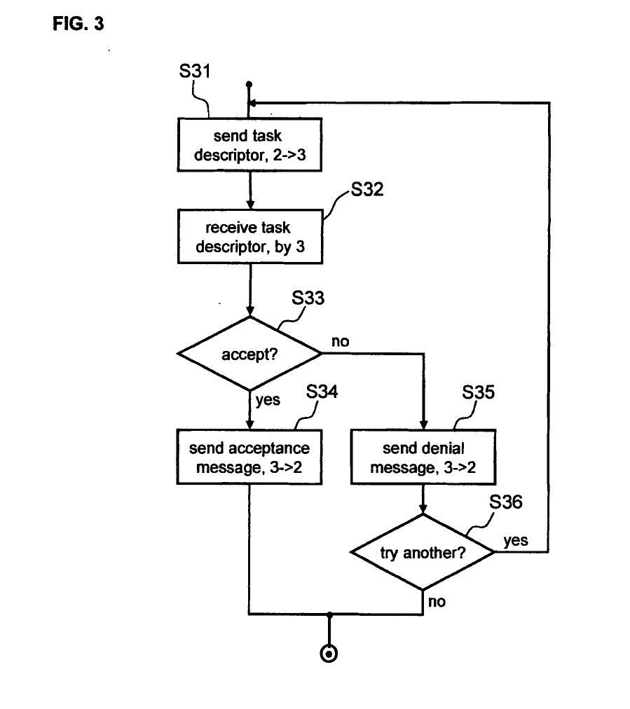

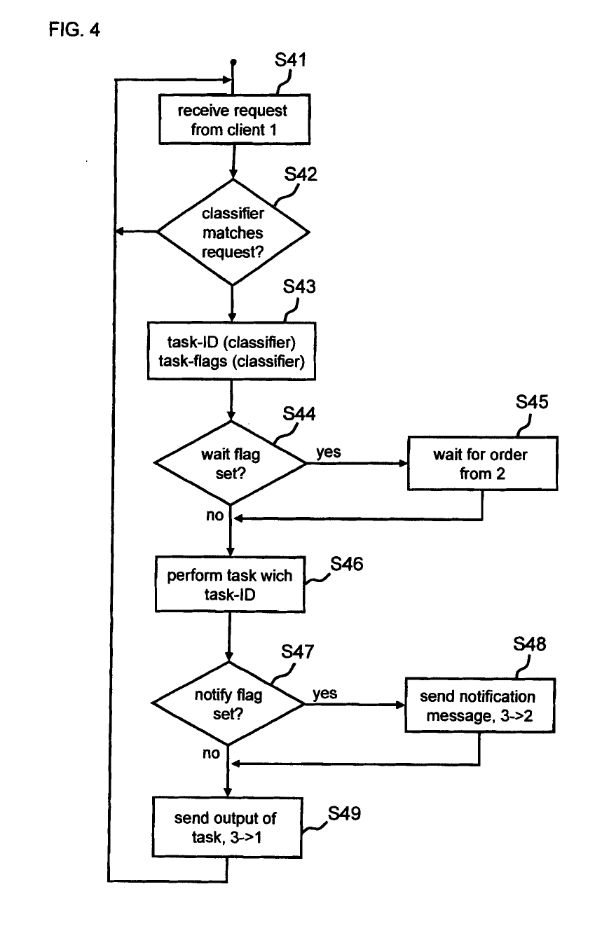

The interaction between client 1, main processing element 2 and the offloading processing elements 3 will be described in more detail in conjunction with the flow charts of FIG. 3 and FIG. 4.

FIG. 2 shows a second embodiment of a system for offloading tasks. It comprises a client 1, a main processing element 2 and an offloading processing element 3a. The client 1 is connected to the main processing element 2 by a network connection 4 and the main processing element 2 is connected to the offloading processing element 3a by a further network connection 5. The client 1 is connected to the offloading processing element 3a by an internal connection 6.

In the system shown in FIG. 2, the main processing element 2 is a forwarding element of a network element. A network element is equipment used in a network to process data transport within the network, for example a router, a network address translator (NAT), a firewall or a load balancer. A forwarding element is the part of a network element that handles data path operations for the data transported, typically on a packet level. Forwarding elements are usually application-specific integrated circuits (ASIC), network processors or general purpose processor-based devices.

Client 1 is a control element of the network element, providing control functionality to the network element, like handling routing and signaling protocols. Control elements are usually based on general purpose processors.

The protocol used to describe interactions between control elements and forwarding elements within network elements usually follows the standardized ForCES (forwarding and control element separation) framework.

The ForCES framework specification is available as an IETF (Internet Engineering Task Force) request for comment (RFC) under number 3746. According to the ForCES framework, the task of compressing a forwarding table used by the network element is assigned to the forwarding element, i.e. here to the main processing element 2. In many cases, however, the control element would be better suited to perform the task of compressing the forwarding table since it usually has higher numerical computing performance. According to the invention, the offloading processing element 3a is located within the control element, i.e. the client 1. In FIG. 2 this is indicated by the dashed line. Since the offloading processing element 3a shares the hardware of client 1, it communicates with the client via the internal connection 6, which might be a software implemented interface like an API (Application Program Interface). The internal connection 6 is adapted to support multicast requests so that communication to the offloading processing element 3a is transparent to the client 1.

After main processing element 2 and offloading processing element 3a have established an offloading relationship concerning the task of compressing the forwarding table, a request of client 1 to store the forwarding table is multicast to the main processing element 2 as well as offloading processing element 3a. The task of compressing will then be performed by the offloading processing element 3a without any interaction with the main processing element 2. The resulting compressed forwarding table is then transmitted from the offloading processing element 3a to the main processing element 2 so that it can be used for packet forwarding purposes. This way, the time and computation power consuming compression task is offloaded to the offloading processing element 3a and thus to the control element-side without violating the separation of the functionality of forwarding and control elements according to the ForCES framework.

FIG. 3 shows a flow chart diagram of the steps for initializing an offloading relationship in one embodiment of a method according to the invention.

The communication between the main processing element 2 and the offloading processing elements 3 is based on a novel protocol as described herein. The protocol is called generic offloading protocol (GOP) and is running on top of a known transport protocol like TCP. The protocol can make use of a structured or semi-structured markup language, for example XML (eXtended Markup Language).

In a first step S31 of FIG. 3 an initialization message is sent from the main processing element 2 to one of the offloading processing elements 3. The initialization message comprises at least one task descriptor. A task descriptor comprises at least a task identifier (task-ID) to define the task to be offloaded. This can, for example, be done by a number referring to a predefined table of possible tasks that is known to the main processing element 2 as well as the offloading processing elements 3. The task descriptor further comprises at least one message classifier assigned to each task. The message classifier can be used to determine requests for which performing a task as described by the assigned task-ID is required. The message classifier can be adapted to operate on any layer of the used transport and/or application protocols. The task descriptor further comprises task update type (TUT) flags which influence details of the course of the method.

Usually, an initialization message will be directed to a particular offloading processing element 3. It would, however, also be possible to multicast initialization messages from the main processing element 2 to all offloading processing elements 3, which then would use further negotiation between the offloading processing elements 3 in order to determine, with which offloading processing element 3 an offloading relationship will finally be established.

Having received the initialization message including at least one task descriptor in a step S32, the addressed offloading processing element 3 can either accept the offloading relationship or deny it (step S33). On accepting the offloading relationship the offloading processing element 3 returns an acceptance message to the main processing element 2 in a step S34, after which the initialization part of the method is finished.

If, in step S33, the addressed offloading processing element 3 does not accept the offloading relationship, the method branches to a step S35. A possible reason not to accept an offloading relationship can be that the addressed offloading processing element 3 does not have enough computing performance or already carries too much load to guarantee an appropriate execution of offloading tasks. In step S35 the offloading processing element 3 sends a denial message to the main processing element 2.

In a step S36 the main processing element 2 evaluates if another offloading processing element 3 could possibly take on the offloading relationship. In that case, the method branches from step S36 back to step S31 to repeat the initialization procedure addressing another offloading processing element 3. If no other offloading processing element 3 is available or if all offloading processing elements 3 have refused to accept the offloading relationship, the method finishes unsuccessfully without having established an offloading relationship.

In another embodiment of the method, in step S31, the initialization may commence with a request from the offloading processing element 3 to the main processing element 2. The request would then be answered by a denial or by an acceptance message from the main processing element 2. An acceptance message would include the at least one task descriptor.

FIG. 4 shows a flow chart of the steps of performing an offloaded task in one embodiment of a method according to the invention.

In a step S41, a request multicast by the client SI via the network connection 4 or the internal connection 6, is received by the main processing element 2 and also all offloading processing elements 3.

In a step S42, each offloading processing element 3 with which an offloading relationship has been established analyses the received request using the message classifiers associated to the task descriptors. If, for a particular offloading processing element 3, no message classifier matches the request, there is no task to be performed by the respective offloading processing element 3. In that case, the method branches back to step S41, ready to receive further requests.

If a message classifier matches the request, the method continues with a step S43. In step S43, the task-ID and the task update type flags, which are assigned to the matching message classifier, are determined from the task descriptor. Due to the concept of correlating tasks and requests using one or more message classifiers, tasks do not have to be mentioned explicitly in the request and can yet be determined as tasks required to process the request.

In a step S44, a wait flag, being part of the task update type flags, is checked. The wait flag determines whether an offloading processing element 3 is allowed to start a task on its own or whether it has to wait for an allowance message from the main processing element 2 (step S45). This mechanism can, for example, be used to synchronize tasks or can be used if the main processing element 2 is set to keep control of the execution of tasks. It can also be used if an exchange of additional information between the main processing element 2 and the offloading processing element 3 is performed before a task can be executed. In another embodiment of the method, step S45 can include sending an allowance request from the offloading processing element 3 to the main processing element 2 beforehand.

If the wait flag is not set or allowance has been given, the method continues with a step S46. In step S46 the task described by the task id is performed by the offloading processing element 3. Performing the task might also include information exchange with the client 1. If, for example, the offloading relationship concerns key management in a storage area network file system as described in conjunction with FIG. 1, the offloaded task to be performed can include the determination of a suitable decryption key for the client 1. This determination might include authorization of the client 1 which would use an exchange of authorization details, like user names and/or passwords between the offloading processing element 3 and the client.

Having finished the offloaded task, a notify flag, which is also part of the task flags, is checked in a step S47. If the notify flag is set, a notification that the task has been completed is used by the main processing element 2. An according notification message is then sent in a step S48 from the offloading processing element 3 to the main processing element 2.

Finally, in a step S49, the output of the task, for example the determined decryption key, is transmitted to the client 1. The method may then start again with step S41, the respective offloading processing element 3 being again ready to receive requests from the client 1. However, the offloading processing elements 3 may anyway be adapted to be able to handle more than one request in parallel using multiple threads or tasks.

The method can also comprise a step of repeatedly transmitting alive messages from each offloading processing element 3 to the main processing element 2. The main processing element 2 can thereby keep track of which offloading processing elements 3 are actually available for offloading. The main processing element 2 can then perform a step of reassigning or removing, for one of the offloading processing elements, the subset of tasks to be performed by the respective offloading processing element 3 if no alive message is received from that offloading processing element 3 for a predetermined time interval. Repeatedly transmitting alive messages allows for a check, whether the offloading processing elements 3 are still up and functioning. If not, the corrupt offloading relationship can be re-established with another offloading processing element 3.

The method for configuring a network device may be implemented in part or as a whole in software or hardware or a combination thereof. The method may, implemented in software, be performed by a computer program product to be executed on a processor assigned to the main processing element and/or to a processor assigned to the at least one offloading processing element. The computer program product may be provided on a computer readable medium embodying software instructions executable by a computer to perform the steps of the method.

The computer-readable medium may, for example, be a CD-ROM, a DVD, a flash memory card, a hard disk, or any other suitable computer-readable medium, e.g. a storage medium within a network.

1. A method for performing tasks when processing a service request of a client by a group of processing elements, the group of processing elements comprising a main processing element and at least one offloading processing element, each offloading processing element being adapted to communicate with the main processing element and the client being adapted to communicate with the main processing element and with each of the offloading processing elements, the method comprising the steps of:
assigning, for at least one of the offloading processing element, a subset of tasks to be performed by the respective offloading processing element;
receiving a service request from the client at the group of processing elements;
determining, by each offloading processing element, whether processing of the service request requires performing a task contained in the subset of tasks assigned to the respective offloading processing element; and
performing one or more tasks by each respective offloading processing element, if processing of the service request requires performing tasks comprised in the subset of tasks assigned to the respective offloading processing element.

2. The method according to claim 1, further comprising a step of sending outputs of the one or more tasks performed by one of the offloading processing elements from the respective offloading processing element to the client.

3. A method for performing tasks when processing a service request by a group of processing elements, the group of processing elements comprising a main processing element and at least one offloading processing element, each offloading processing element being adapted to communicate with the main processing element, the method comprising the steps of:
assigning, for at least one of the offloading processing elements, a subset of tasks to be performed by the respective offloading processing element;
receiving a service request;
determining, by each offloading processing element, whether the service request requires performing a task contained in the subset of tasks assigned to the respective offloading processing element;
performing one or more tasks by each respective offloading processing element, if the service request requires performing tasks comprised in the subset of tasks assigned to the respective offloading processing element.

4. The method according to claim 1, further comprising a step of, if further tasks other than the tasks performed by the offloading processing element are required to complete processing of the service request, performing the further tasks by the main processing element.

5. The method according to claim 1, wherein the first step of assigning the subset of tasks is performed once and the further steps are performed for a plurality of service requests.

6. The method according to claim 1, wherein the first step of assigning the group of tasks comprises transmitting an initialization request from the main processing element to the offloading processing element, the initialization request comprising a task descriptor.

7. The method according to claim 6, wherein
the task descriptor comprises a task identifier referring to a predefined table of tasks and at least one message classifier assigned to the task identifier; and where
the step of determining, by each offloading processing element, whether the service request comprises a task contained in the subset of tasks assigned to the respective offloading processing element comprises analyzing the service request using the at least one message classifier; and where
a task performed by the respective offloading processing element depends on the task identifier assigned to the at least one message classifier.

8. The method according to claim 1, further comprising a step of sending a notification message from each respective one of the offloading processing elements to the main processing element after the respective offloading processing element has performed the one or more tasks to process the service request.

9. The method according to claim 1, further comprising a step of transmitting data used to perform the one or more tasks by one of the offloading processing elements from the main processing element to the respective offloading processing element.

10. The method according to claim 1, further comprising a step of periodically transmitting alive messages from each offloading processing element to the main processing element.

11. The method according to claim 10, further comprising a step of reassigning, for one of the offloading processing elements, a subset of tasks to be performed by the respective offloading processing element if no alive message of one of the other offloading processing element is received for a predetermined time interval.

12. The method according to claim 3, further comprising a step of, if further tasks other than the tasks performed by the offloading processing element are required to complete processing of the service request, performing the further tasks by the main processing element.

13. The method according to claim 3, further comprising a step of transmitting data used to perform the one or more tasks by one of the offloading processing elements from the main processing element to the respective offloading processing element.

14. The method according to claim 3, further comprising a step of periodically transmitting alive messages from each offloading processing element to the main processing element.

15. The method according to claim 14, further comprising a step of reassigning, for one of the offloading processing elements, a subset of tasks to be performed by the respective offloading processing element if no alive message of one of the other offloading processing element is received for a predetermined time interval.

16. Computer program product comprising a computer-readable medium embodying program instructions executable by at least one processor to perform a method for performing tasks when processing a service request of a client by a group of processing elements, the group of processing elements comprising a main processing element and at least one offloading processing element, each offloading processing element being adapted to communicate with the main processing element and the client being adapted to communicate with the main processing element and with each of the offloading processing elements, the method comprising the steps of:
assigning, for at least one of the offloading processing element, a subset of tasks to be performed by the respective offloading processing element;
receiving a service request from the client at the group of processing elements;
determining, by each offloading processing element, whether processing of the service request requires performing a task contained in the subset of tasks assigned to the respective offloading processing element; and
performing one or more tasks by each respective offloading processing element, if processing of the service request requires performing tasks comprised in the subset of tasks assigned to the respective offloading processing element.

17. A system for performing tasks when processing a service request comprising a group of processing elements, the group of processing elements comprising a main processing element and at least one offloading processing element, each offloading processing element being adapted to communicate with the main processing element, characterized in that the system is operable to perform a method for performing tasks when processing a service request of a client by a group of processing elements, the group of processing elements comprising a main processing element and at least one offloading processing element, each offloading processing element being adapted to communicate with the main processing element and the client being adapted to communicate with the main processing element and with each of the offloading processing elements, the system comprising:
a task assignment section for assigning, for at least one of the offloading processing element, a subset of tasks to be performed by the respective offloading processing element;
at least one communication section for receiving a service request from the client at the group of processing elements; and
an analysis section, at each offloading processing element, for determining whether processing of the service request requires performing a task contained in the subset of tasks assigned to the respective offloading processing element, whereby each respective offloading processing element performs task processing, if processing of the service request requires performing tasks comprised in the subset of tasks assigned to the respective offloading processing element.

18. The system according to claim 17, further comprising a notification section at each offloading processing element for sending a notification message from each respective one of the offloading processing elements to the main processing element after the respective offloading processing element has performed the one or more tasks to process the service request.

19. The system according to claim 17, further comprising a transmitting section at said main processing element for transmitting data used to perform the one or more tasks by one of the offloading processing elements from the main processing element to the respective offloading processing element.

20. The system according to claim 17, further comprising a message generating section at each offloading processing element for periodically transmitting alive messages from each offloading processing element to the main processing element.
